(19) United States
(12) Patent Application Publication
(10) Pub. No.: US 2005/0000583 A1
(43) Pub. Date: Jan. 6, 2005

(54) Drainpipe for water-dischargeable pavement and water-dischargeable pavement body

(76) Inventors: Hiroyuki Masui, Takatsuki-shi (JP); Tsunehiro Naba, Takatsuki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/786,113

(22) Filed: Feb. 26, 2004

(30) Foreign Application Priority Data
Feb. 26, 2003 (JP) 2003-49373

(51) Int. Cl. F16L 11/00

(52) U.S. Cl. 138/137; 138/178

(57) ABSTRACT

A drainpipe embedded in a water-permeable layer of a water-dischargeable pavement body is molded by using as a constitutional material a material which is degraded or disintegrated and disappears the tubular shape thereof with the passage of time in a natural environment, for example, a biodegradable resin.

### BACKGROUND OF THE INVENTION

1. Field of the Invention

The present invention relates to a drainpipe embedded in a pavement body provided with a water-dischargeable pavement, for example, in roads, bridges, and parking areas, and serving for discharging the rainwater or the like that penetrated into the pavement body to the outside. Furthermore, the present invention also relates to a water-dischargeable pavement body that uses such a drainpipe.

2. Description of the Related Art

In a pavement body provided with a water-dischargeable pavement, a surface layer is a water-permeable layer made from a porous asphalt mixture with a high porosity. A water-impermeable layer made from an asphalt mixture is provided below the water-permeable layer. The rainwater that fell on the road surface immediately permeates into water-permeable layer without staying on it, flows over the upper surface of the water-impermeable layer, and is discharged to the outside without permeating into the road foundation or bed.

Therefore, in a water-dischargeable pavement body of this type, no rainwater remains on the road surface and safety during vehicle movement can be increased. Furthermore, traffic noise can be also reduced because the engine noise or air pumping sound of tires is absorbed by pores of the water-permeable layer.

Some of such water-dischargeable pavement bodies have a structure in which drainpipes are embedded in the water-permeable layer to discharge effectively the rainwater permeated into the water-permeable layer to the outside.

Examples of such drainpipes include a mesh-like pipe made of a synthetic resin, as disclosed in Japanese Patent Laid-Open Number 2001-11924 and a perforated pipe made of a synthetic resin, as discloses in Japanese Patent Laid-Open Number 1998-195855. Further, Japanese Patent Laid-Open Number 2002-181247 discloses a drainpipe in which an outer film obtained by knitting the fiber threads made of a synthetic resin is wound around the outer periphery of a spring made from a metal or a synthetic resin.

However, the drainpipes made from a synthetic resin or a metal that are embedded in the conventional pavement body remained semi-permanently in the pavement body. As a result, holes on the pipe wall were, for example, clogged after a long-term use and the water draining performance thereof gradually degraded.

Moreover, when the wasted asphalt of the surface layer was ground and used as a regenerated aggregate in the process of replacing the surface layer during pavement body repair, a complex operation of removing the drainpipes from the surface layer and separating the drainpipes from the asphalt components had to be conducted. Furthermore, the waste treatment of the separated drainpipes was also troublesome, and when they were incinerated, a problem was associated with the generation of toxic combustion gases. For those reasons, at present, asphalt wastes generated when the pavement bodies are repaired are not substantially regenerated or reused.

### SUMMARY OF THE INVENTION

It is an object of the present invention to resolve the above-described problems and to maintain good water draining performance of a pavement body for a long time. Another object of the present invention is to enhance recycle of wastes generated when the pavement bodies are repaired.

In order to attain those objects, the drainpipe for a water-dischargeable pavement in accordance with the present invention is embedded in a water-dischargeable pavement body and employs a constitutional material, which is degraded or disintegrated finally to make its tubular shape disappeared thereof with the passage of time in a natural environment.

Thus, this drainpipe employs a constitutional material to degrade or to disintegrate according to various natural environmental factors such as microorganisms in soils etc, sunlight, air, heat, water and so on, and then at least its tubular shape disappears, regardless of that it finally comes to carbon-dioxide and water.

As a result, the drainpipe embedded in the water-permeable layer of a water-dischargeable pavement body is degraded or disintegrated with the passage of time and eventually disappears. Therefore, the occurrence of clogging, as in the conventional drainpipes, is prevented and good water draining performance of the pavement body can be maintained for a long time. Moreover, such a disappearance of the drainpipes makes it unnecessary to remove the drainpipes from the water-permeable layer or to process the drainpipes as wastes. As a result, regeneration and reuse of asphalt wastes produced when the pavement body is repaired can be enhanced and environmental load can be reduced.

More specifically, a biodegradable resin that is degraded under the effect of microorganisms is used as the aforesaid material. Further, compositions prepared by adding to a synthetic resin a degradation enhancing agent that enhances the degradation of the synthetic resin in a natural environment is used as the aforesaid material.

If a biodegradable resin or a synthetic resin having a degradation enhancing agent added thereto is thus used as a constitutional material for a drainpipe, finally non-toxic products such as water and carbon dioxide are eventually obtained and environmental load can be further reduced.

Furthermore, the drainpipe for a water-dischargeable pavement in accordance with the present invention comprises pipe walls having a plurality of holes for water permeation. Thus forming a plurality of holes for water permeation in the pipe wall of the drainpipe allows good water draining performance to be demonstrated immediately after the drainpipe has been embedded in the water-permeable layer. In addition, because of easier contact of the drainpipe with water, air and microorganisms, the drainpipe itself can disappear faster.

In the water-dischargeable pavement body in accordance with the present invention, the aforesaid drainpipe is embedded in a water-permeable layer, and the water that permeated into the water-permeable layer is discharged to the outside through the drainpipe.

### BRIEF DESCRIPTION OF THE DRAWINGS

FIG. 1 is a longitudinal sectional view of a water-dischargeable pavement body of one embodiment of the present invention;

FIG. 2 is a partially cut-out side view of a drainpipe of the water-dischargeable pavement body;

FIG. 3 is a partially cut-out side view of a drainpipe of another embodiment;

FIG. 4 is a side view of a drainpipe of yet another embodiment;

FIG. 5 is a side view of a drainpipe of still another embodiment; and

FIG. 6 is a perspective view of a drainpipe of yet another embodiment.

### DESCRIPTION OF THE PREFERRED EMBODIMENTS

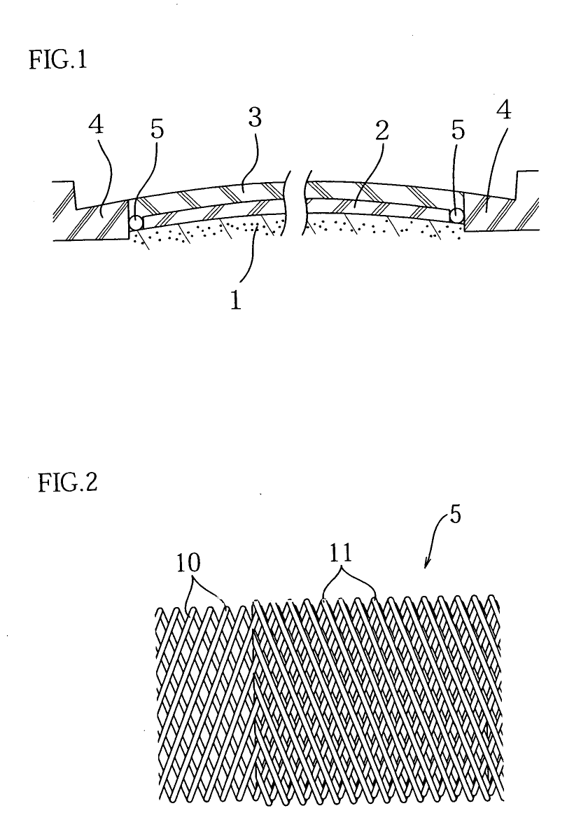

FIG. 1 shows a water-dischargeable pavement body of one embodiment of the present invention. In the figure, the reference numeral 1 stands for a road foundation laid on a road bed, 2—a base layer laid on the road foundation 1, 3—a surface layer laid on the base layer 2, and 4—a road ditch provided along the side of the surface layer 3.

The base layer 2 and surface layer 3 are, for example, constructed by laying an asphalt mixture to a thickness of about 5 cm. The base layer 2 serves as a water-impermeable layer, and the surface layer 3 serves as a water-permeable layer with a high porosity.

Therefore, the rainwater that fell on the road surface penetrates into the water-permeable layer 3 and is guided sidewise along the upper surface of the water-impermeable layer 2 that is curved so that the center thereof is raised.

Drainpipes 5, 5 for effectively discharging the rainwater that was guided sidewise to the outside are embedded in the side portions of the water-permeable layer 3 along the extension direction thereof.

The drainpipe 5, for example, has a mesh-like pipe structure in which, as shown in FIG. 2, spiral inner linear materials 10, 10 . . . and spiral outer linear materials 11, 11 are thermally fused or bonded so as to cross each other. A mesh-like pipe structure may be also employed in which not only the inner and outer linear materials 10, 11 are joined together as mentioned above, but the linear materials of different directions are intertwined.

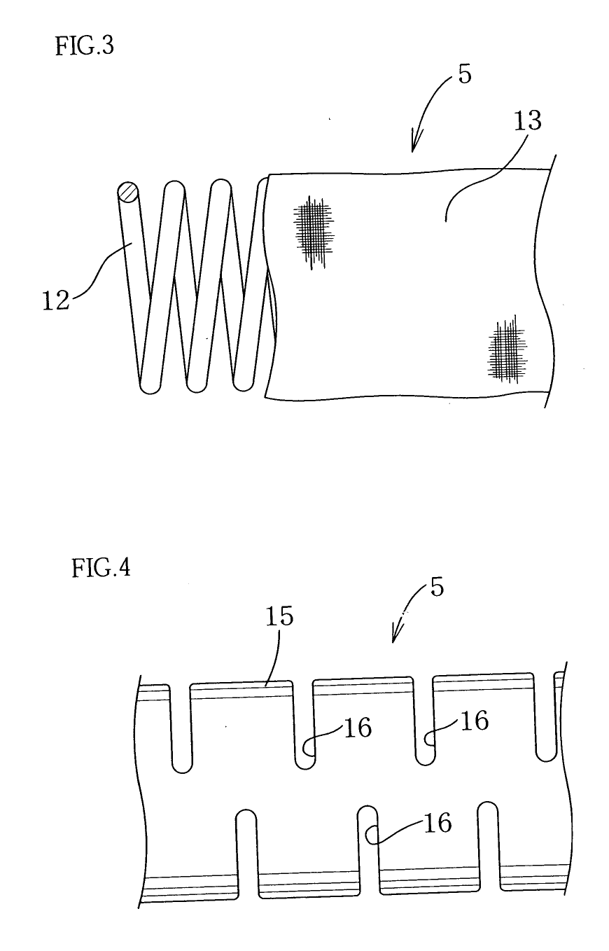

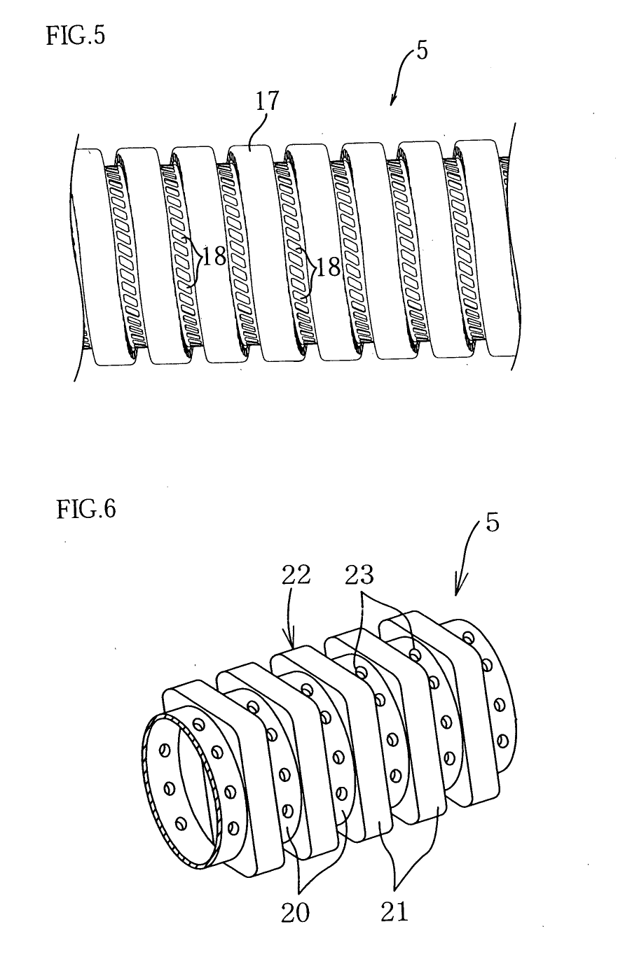

Furthermore, the drainpipe 5 may have a composite structure in which an outer film 13 obtained by knitting the fiber threads is wound around the outer periphery of a spring-like core 12, as shown in FIG. 3. Moreover, the drainpipe 5 may also have a perforated pipe structure in which holes 16, 16 . . . for water permeation are formed in the locations in need on a cylindrical tubular wall 15, as shown in FIG. 4. Further, the drainpipe 5 may also have a corrugated pipe structure which comprises a corrugated tubular wall 17 in which peaks and valleys are continuously arranged in the axial direction and has holes 18, 18 . . . for water permeation formed in the locations in need on a cylindrical tubular wall 17, as shown in FIG. 5. Moreover, the drainpipe 5 may also have a corrugated pipe structure which comprises corrugated tubular wall 22 in which round pipe sections 20, 20 . . . and angular pipe sections 21, 21 . . . continuously alternate in the axial direction and has holes 23, 23 . . . for water permeation formed in the prescribed locations of a cylindrical tubular wall 22. With the structure shown in FIG. 6, because the drainpipe 5 is prevented from rolling over by the angular pipe sections 21, 21, the operability of during pipe installation can be increased.

Pipes of a variety of the above-described structures can be considered as a drainpipe 5, but essentially any structure may be employed, provided that it has holes for water permeation in the prescribed positions of the pipe wall so that rainwater or the like that oozed into the water-permeable layer 3 can penetrate into the pipe. It is preferred that the pipe have a structure with excellent flexibility, while having a high compression strength.

The above-described drainpipe 5 is formed of a constitutional material, that is to degrade or to disintegrate so as to make its tubular shape disappeared thereof in the course of time under a natural environment.

More specifically, a biodegradable resin that undergoes metabolic degradation under the degrading effect of microorganism is used as the constitutional material. Examples of such biodegradable resins include natural bioplastics, microbial bioplastics, chemically synthesized bioplastics, or blends of those plastics.

Examples of natural bioplastics include starch, cellulose and its derivatives, marine polysaccharides such as chitin and chitosan, or their derivatives, shellac and so on.

Examples of microbial bioplastics include microbial polysaccharides such as curdlan and pullulan and polyamino acids such as polyglutamic acid, polylysine and so on.

Examples of chemically synthesized bioplastics include polycaprolactones, polyurethanes, polyamides e.g., oligomers of Nylon 6, polyvinyl alcohol, polyglycolic acid, polylactic acid, aliphatic polyesters, polyethers and so on.

Practically most of such biodegradable resins are degraded under the effect of microorganisms, eventually yielding water and carbon dioxide, or organic components.

Furthermore, in addition to the above-described biodegradable resins, materials obtained by adding degradation enhancing agent that enhance the degradation of synthetic resins in a natural environment to synthetic resins may be also employed as the constitutional material. DegraNovon trade name marketed by Novon Japan Co. as an agent for enhancing the oxidation and degradation of thermoplastic polymers under the effect of UV component of solar radiation, heat, oxygen, and microorganisms can be used as the degradation enhancing agent, and a material prepared by adding the DegraNovon to a thermoplastic polymer can be considered as the constitutional material.

Examples of thermoplastic polymers to which the DegraNovon can be added include polyurethanes, polystyrene polyolefins, ethylene/vinyl acetate-copolymers, ethylene/vinyl alcohol-copolymer, ethylene/acrylic acid- copolymers, ethylene/methyl acrylate-copolymers, ethylene methacrylic acid copolymer, ethylene vinyl alcohol, polyvinyl alcohol, ethylene vinyl alcohol carbon monoxide copolymer, ethylene butylacrylate, polymethyl methacrylate, polyethylene oxide and so on.

Most of the materials obtained by adding DegraNovon to those thermoplastic polymers are oxidized and degraded by UV radiation heat, oxygen, and microorganisms. As a result, their molecular weight is decreased and they are disintegrated into fine particles. This disintegration into fine particles can be accelerated if the oxidation and disintegration process is enhanced by using heat of asphalt immediately after it was placed. The fine particles are further digested by microorganisms and eventually converted into water and carbon dioxide.

The above-described biodegradable resins or synthetic resins having degradation enhancing agent added thereto are eventually converted into non-toxic products such as water and carbon dioxide and environmental load thereof is reduced. Moreover, materials that at least their tubular shape disappear, independently of whether they are eventually converted into water and carbon dioxide, may be also used as the constitutional material for the drainpipe 5. Examples of constitutional materials other than the biodegradable resins or synthetic resins having degradation enhancing agent added thereto include water-soluble inorganic salts such as table salt or potassium chloride, copolymers of starch and polyethylene, and simple water-soluble polymers.

In the water-dischargeable pavement of the above-described configuration, rainwater that permeated from the road surface into the water-permeable layer 3 is guided sidewise along the top surface of the water-impermeable layer 2. The rainwater then penetrates into the drainpipes 5 embedded in the side portion of the water-permeable layer 3, passes through the drainpipe 5 and is effectively discharged to the external catch basin or side ditch. Therefore, rainwater is not accumulated on the road surface of the pavement. As a result, slipping or splashing during vehicle movement can be prevented and safety can be increased. Furthermore, noise is absorbed by pores of the water-permeable layer 3 and the level of traffic noise can be reduced.

Further, the drainpipes 5 embedded in the water-permeable layer 3 are degraded or disintegrated and eventually disappear under the effect of various environments of the natural world, such as microorganisms, UV radiation of sunlight, heat, and water, in a long-term use. After the drainpipe 5 disappears, a tubular draining cavity surrounded by asphalt particles is maintained in the zone where the drainpipe 5 was present in the water-permeable layer 3.

As a result, the conventional clogging of drainpipes in a long-term use can be avoided and good water draining performance of the pavement body can be maintained. Moreover, when the asphalt of the surface layer 3 that became a waste is ground and used as a regenerated aggregate in the process of replacing the surface layer 3 during pavement body repair, a complex operation of removing the drainpipes 5 from the surface layer 3, that is, from the water-permeable layer, can be eliminated. Furthermore, the waste treatment such as incineration of the drainpipes 5 also becomes unnecessary. Therefore, a contribution can be made to the increase in regeneration and reuse ratio of asphalt waste and environmental load can be greatly reduced.

The present invention is not limited to the above-described embodiments, and it goes without saying that various changes or modifications of the embodiments can be made within the scope of the present invention.

1. A drainpipe for a water-dischargeable pavement body, which is embedded into the water-dischargeable pavement body, wherein a material to degrade or to disintegrate finally to make the tubular shape disappeared thereof with the passage of time under a natural environment is employed to constitute the drainpipe.

2. The drainpipe for a water-dischargeable pavement body, as described in claim 1, wherein said material is a biodegradable resin to degrade by the action of microorganisms.

3. The drainpipe for a water-dischargeable pavement body, as described in claim 1, wherein a material is comprised of a synthetic resin, to which a degradation enhancing agent to facilitate the degradation of said synthetic resin is added.

4. The drainpipe for a water-dischargeable pavement body, as described in claim 1, which comprises a pipe wall having a plurality of holes for water permeation.

5. The drainpipe for a water-dischargeable pavement body, as described in claim 2, which comprises a pipe wall having a plurality of holes for water permeation.

6. The drainpipe for a water-dischargeable pavement body, as described in claim 3, which comprises a pipe wall having a plurality of holes for water permeation.

7. A water-dischargeable pavement body, wherein the drainpipe described in claim 1 is embedded in a water-permeable layer and the water that permeated into the water-permeable layer is discharged to the outside, via said drainpipe.

8. A water-dischargeable pavement body, wherein the drainpipe described in claim 2 is embedded in a water-permeable layer and the water that permeated into the water-permeable layer is discharged to the outside via said drainpipe.

9. A water-dischargeable pavement body, wherein the drainpipe described in claim 3 is embedded in a water-permeable layer and the water that permeated into the water-permeable layer is discharged to the outside via said drainpipe.

10. A water-dischargeable pavement body, wherein the drainpipe described in claim 4 is embedded in a water-permeable layer and the water that permeated into the water-permeable layer is discharged to the outside via said drainpipe.

11. A water-dischargeable pavement body, wherein the drainpipe described in claim 5 is embedded in a water-permeable layer and the water that permeated into the water-permeable layer is discharged to the outside via said drainpipe.

12. A water-dischargeable pavement body, wherein the drainpipe described in claim 6 is embedded in a water-permeable layer and the water that permeated into the water-permeable layer is discharged to the outside via said drainpipe.
